(19) United States
(12) Patent Application Publication
(10) Pub. No.: US 2016/0123470 A1
(43) Pub. Date: May 5, 2016

(54) SEAL ASSEMBLY

(71) Applicants: Wolfgang Glaentz, Schweinfurt (DE); Thomas Heege, Sennfeld (DE); Hubert Herbst, Gadheim (DE); Jos Holsnijders, EN Leerdam (NL); Armin Olschewski, Schweinfurt (DE); Thomas Peuschel Peuschel, Schonungen/Marktsteinach (DE); Hans-Joachim vom Stein, Odenthal (DE)

(72) Inventors: Wolfgang Glaentz, Schweinfurt (DE); Thomas Heege, Sennfeld (DE); Hubert Herbst, Gadheim (DE); Jos Holsnijders, EN Leerdam (NL); Armin Olschewski, Schweinfurt (DE); Thomas Peuschel Peuschel, Schonungen/Marktsteinach (DE); Hans-Joachim vom Stein, Odenthal (DE)

(73) Assignee: AKTIEBOLAGET SKF, Goteborg (SE)

(21) Appl. No.: 14/926,910

(22) Filed: Oct. 29, 2015

(30) Foreign Application Priority Data
Oct. 29, 2014 (DE) 10 2014 222 100.5

(51) Int. Cl. F16J 15/3208; F16J 15/3284; F16J 15/3232

(52) U.S. Cl. CPC F16J 15/3208; F16J 15/3232; F16J 15/3284

(57) ABSTRACT

A seal assembly for sealing a space between a first component and a second component includes a seal base body disposed on the first component and having at least first and second seal lips configured to run on a running surface of the second component with the seal lips contacting the second component at first and second axially spaced locations, the seal base body including an annular channel having an opening facing in the axial direction, and at least one cylinder comprising a bimetallic shape-change element, the cylinder having a first end in the annular channel of the seal base body and a second end outside the annular channel, at least a portion of the cylinder being located axially between the first seal lip and the second seal lip and radially inward or outward from the second seal lip.

### CROSS-REFERENCE

This application claims priority to German patent application no. 10 2014 222 100.5 filed on Oct. 29, 2014, the contents of which are fully incorporated herein by reference.

### TECHNOLOGICAL FIELD

The disclosure is directed to a seal assembly for sealing a first space with respect to a second space, and, more specifically, toward a seal assembly having two seal lips and a temperature sensitive adjustment element for adjusting a relationship between the lips and a contact surface.

### BACKGROUND

Seal assemblies of the above type are well known in the art. They may be configured as radial shaft seals that have seal lips that abut on a shaft in a rubbing or sliding manner. These seals include a seal base body that is connected to a housing section and define a sealed-off space in the housing interior that is sealed-off with from the environment. This space, in which, for example, a rolling-element bearing can be disposed, is filled with a lubricant such as lubricating grease.

A seal assembly of the above-described type is known from DE 10 2007 045 819 A1 (family member of U.S. Pat. No. 8,602,419). DE 10 2011 086 954 A1 discloses another seal that includes a temperature-sensitive adjusting element.

Seal assemblies of this type are used, for example, in wheelset bearings of railway vehicles or motor vehicles. They can be configured as non-contact seals (gap-type or labyrinth seals) or contact seals of the above-described type. These seals can be directly integrated in a rolling-element bearing or used as a separate external unit. These two seal concepts—non-contact seals and contact seals—have respective advantages and disadvantages.

Contact seals have a certain defined contact area between the seal lips and a shaft or bearing ring or other countersurface on which they run. This area of contact is needed to provide a good sealing effect, but it also creates friction and heat development. Heating may therefore occur, and this heating can further increase friction and eventually cause wear between the rubbing surfaces (i.e., between the seal lips and the countersurface). The seal lip material is preferably comprised of an elastomer material.

The seal contact area varies because of manufacturing tolerances of the seal lip diameter and the shaft diameter. This variance is usually greater than 0.1 mm. This disadvantageously leads to a different frictional behavior of the different installed seals due to the variations in contact area. However, generally these seals are well suited for protecting bearings from external contamination. Furthermore, these seals retain lubricant in an efficient manner, i.e., a rolling-element bearing grease used for bearing lubrication is retained well in the bearing; the escape of lubricant (grease) is minimized.

Non-contact seals (i.e., gap-type seals), on the other hand, do not seal as well as contact seals and do not protect as well against external contamination of the bearing. To minimize the ingress of contaminants into the sealed location, the seal gap between the seal inner diameter and the countersurface (such as, e.g., the bearing inner ring or shaft journal) must be kept as small as possible. This disadvantageously requires a high degree of technical effort in maintaining tight manufacturing tolerances, thereby incurring correspondingly high costs. Escape of lubricating grease from the bearing can also result. This is particularly true with the use of low-viscosity rolling-element bearing greases. Due to the possibility of grease escaping from such seals, low-viscosity bearing greases, which are in principle favorable (in particular in rail-vehicle bearing sets) are sometimes avoided, even though they are in fact optimal with respect to lubricating function and thus with respect to bearing service life and temperature development.

### SUMMARY

A first aspect of the disclosure is to provide a seal assembly of the above-mentioned type such that provides an optimal contact area or preload of the seal lip on a to-be-sealed component, in particular on a shaft, in all operating conditions. This allows for efficient sealing while at the same time avoids generating excessive friction between the seal lip and the to-be-sealed shaft in the assembly to be sealed, even with increasing temperature. The disclosure thus minimizes frictional losses, and this may result in energy savings as well as a CO₂ reduction. Furthermore a maximum service life of a bearing can thereby be ensured.

The disclosure is characterized in that the temperature-sensitive adjusting element is configured as a sleeve that extends in an axial direction concentric to the axis of rotation, and the temperature-sensitive adjusting element is connected to a seal base body at one axial end. The other axial end of the temperature-sensitive adjusting element is cantilevered or free from direct attachment to the seal base body. The seal base body includes a retaining section for retaining the temperature-sensitive adjusting element, which retaining section is configured as a bent section, and the retaining section embraces or holds one axial end of the temperature-sensitive adjusting element or a retaining element for the temperature-sensitive adjusting element.

In another aspect of the disclosure a seal assembly is provided for sealing a space between a first component and a second component, the second component having an axis of rotation extending in an axial direction. The seal assembly includes a seal base body disposed on the first component that has at least first and second seal lips configured to run on a running surface of the second component with the seal lips contacting the second component at first and second axially spaced locations. The seal base body has an annular channel having an opening facing in the axial direction. The assembly also includes at least one cylinder comprising a bimetallic shape-change element, the cylinder having a first cylinder end in the annular channel of the seal base body and a second cylinder end outside the annular channel, at least a portion of the cylinder being located axially between the first seal lip and the second seal lip and radially inward or outward from the second seal lip.

The temperature-sensitive adjusting element is preferably disposed such that in the event of a temperature increase one of two seal lips does not move radially away from the second component.

The temperature-sensitive adjusting element is preferably a bimetallic element or comprises such a bimetallic element.

The sleeve can be provided with slots over its circumference that extend axially at least over a part of its axial extension. The ability of the temperature-sensitive adjusting element to expand radially in the event of temperature increases is thereby encouraged in this slotted region.

The seal base body is preferably comprised of a bent metal plate. It can be at least partially encased in elastomer material from which the seal lips are also formed.

According to a preferred use, the first component is a housing and the second component is a rotating shaft.

As mentioned above, the radial running of the seal lips on the second component can be direct or indirect. In the case of direct abutment, the seal lips abut directly on a cylindrical surface of the second component (shaft). In the case of indirect abutment, a running sleeve, for example, is installed on the second component, and seal lips run in direct abutment with the running sleeve.

A bimetallic element (also referred to as thermobimetal) preferred for use is a metallic element comprised of two layers of different metals that are connected to one another in a materially-bonded or interference-fit manner. The material of each layer has a different coefficient of thermal expansion, and thus changes in temperature cause one element to expand or contract more than the other element. This causes the element to bend. These metals can be, for example, zinc and steel, or steel and brass. The two metals having different linear expansion coefficients lengthen during heating by different amounts. If the two ends of the two metal elements are connected (for example, by riveting or rolling), the different length changes lead to a bending of the bimetallic element.

Bimetals are usually manufactured in sheet- or strip-form. The bare metals, free of oxide layers, are rolled together under pressure. In the contact zone a permanent connection is created by cold or hot welding. In another embodiment the metal ends are congruently provided with through-bores and riveted or screwed together.

According to the disclosure a self-adjusting contact area or preload of the seal lips radially abutting on the shaft thus results, and the coverage or preload changes with the temperature.

The disclosure is thus directed to a contact-seal concept that is configured as a passively controlled sealing system. Control of the radial abutment pressure on the shaft results from the temperature prevailing in the seal assembly. For this purpose a temperature-sensitive adjusting element, in particular a bimetallic element, is provided, which controls the contact area or the radial preload of the seal lips on the shaft.

A hybrid construction in which the bimetallic element is integrated in the elastomer material of the seal is possible. However, the bimetallic element can also be seated on, e.g., adhered to, the elastomer material of the seal.

Although a bimetallic element is preferably used as a temperature-sensitive adjusting element, in general any thermally sensitive material can be used that changes its shape under the influence of temperature. In the simplest case a ring made of a material can be applied near the first and second seal lips which material has a very different thermal expansion coefficient than that of the elastomer material of the seal. As a result, with temperature increase, at least one of the seal lips lifts radially from its countersurface of the part to be sealed and thus reduces the contact area or the contact pressure on the countersurface.

Using the disclosed solution it is possible to reduce the contact area or contact pressure of the seal lips on the countersurface to be sealed so that the friction can be reduced. In this way an energy savings as well as a reduction of CO₂ emissions is possible. Furthermore, in the case specified a rotational speed increase is possible since the friction is reduced.

As a result, lower costs arise over the service life of the seal assembly.

Furthermore, a maintenance interval can be lengthened because less wear is to be expected. The seal service life and bearing service life are thus extended in an advantageous manner.

Finally, a reduction in the required amount of lubricant is possible.

The proposed seal assembly is particularly preferably used for wheel bearings, in particular in railway vehicles and motor vehicles.

### BRIEF DESCRIPTION OF THE DRAWINGS

Exemplary embodiments of the disclosure are depicted in the drawings.

FIG. 1 is a radial section through a seal assembly that is installed between a housing and a rotating shaft.

FIG. 2 is a radial section of a part of the seal assembly according to an alternative embodiment.

FIG. 3 is a perspective view of a modified version of the temperature-sensitive adjusting element (bimetallic element) of the embodiment of FIG. 1.

FIG. 4 is a perspective view of a modified version of the temperature-sensitive adjusting element (bimetallic element) of the embodiment of FIG. 2.

### DETAILED DESCRIPTION

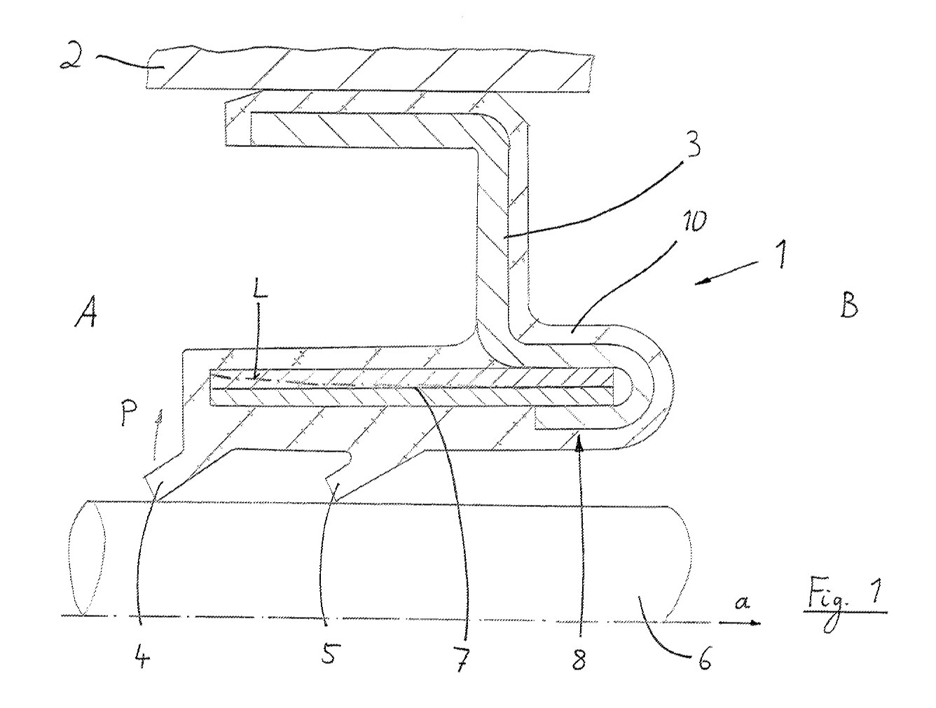

In FIG. 1 a first component 2, in this case a housing, and a second component 6, in this case a rotating shaft, are depicted. Between the first component 2 and the second component 6 a seal assembly 1 is disposed, using which seal assembly 1 a first space A, which may be filled with lubricant, is sealed with respect to a second space B, which may be the environment.

The seal assembly 1 includes a seal base body 3 that includes a metal plate and is manufactured by bending a metal plate into a suitable form. The seal base body 3 is formed as a rotationally symmetric ring element. It is partially covered by elastomer material 10, and two seal lips 4 and 5 are also formed from the elastomer material 10. The two seal lips 4 and 5 abut on the shaft 6 and are spaced from one another in an axial direction a.

As can further be seen in FIG. 1, the seal base body 3 is bent in its radially-inner-lying region in order to form a retaining section 8 (an axially facing annular channel) for a bimetallic element 7, that is, for a temperature-sensitive adjusting element. The bimetallic element 7 is pushed axially into the retaining section 8 and held such that the bimetallic element 7 (as viewed in the radial direction) extends away from the retaining section 8 in the axial direction a.

When the temperature of the seal assembly increases, the bimetallic element 7 changes its shape so that the first seal lip 4 moves away radially from the second component 6. The direction of this movement is indicated by the arrow P. However, the bimetallic element 7—as can be seen in FIG. 1—is disposed such that the second seal lip 5 moves radially away from the second component 6 a smaller distance or not at all.

In FIG. 1 the position of the seal lips is shown at ambient temperature (20° C.). However, the bend line L of the bimetallic element 7 is also shown. At increased temperatures, the bimetallic element will bend along this bend line L, and this makes it immediately obvious that when the temperature increases the first seal lip 4 will moves much farther away from the shaft 6—and possibly even lift away from it—than will the second seal lip 5.

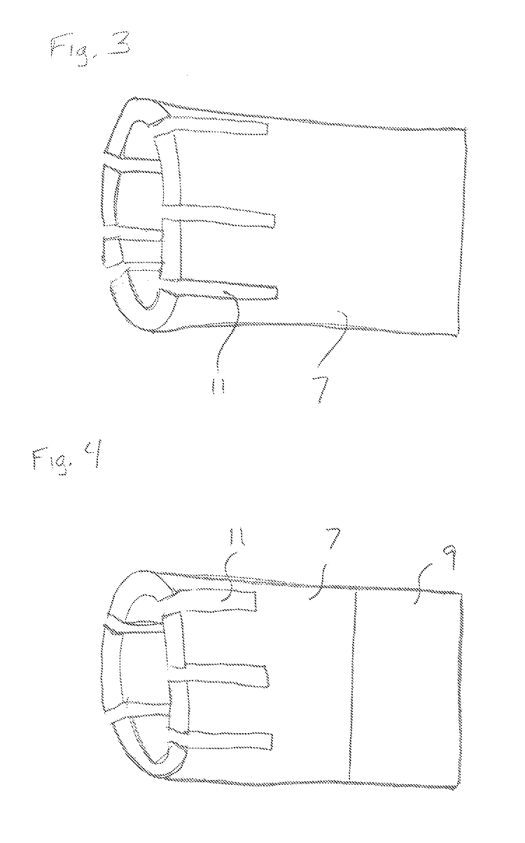

The temperature responsive mobility of the preferably sleeve-shaped or hollow-cylindrically configured bimetallic element 7 can be increased by providing slots 11 (illustrated in FIG. 3 and FIG. 4) over the circumference of the bimetallic element 7. With the aim of improving said mobility, it is possible to introduce the slots only in an axial region of the bimetallic element 7 (namely in the left half of the bimetallic element 7 as seen in FIG. 1). Thus only the first seal lip 4 will move in response to temperature increases. The right half of the bimetallic element 7, which is kept free of slots, then does not change its shape with temperature increase, or hardly changes its shape, so that the second seal lip 5 essentially remains in the position depicted.

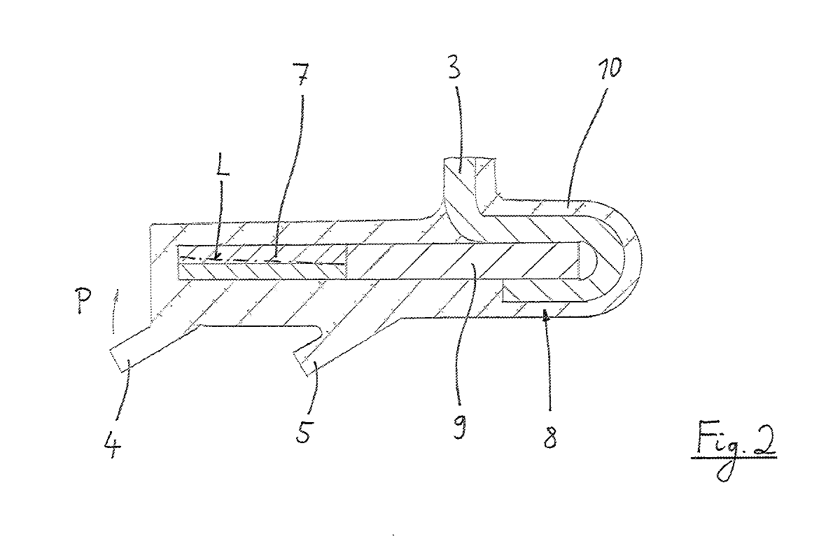

In FIG. 2 an alternative arrangement of a bimetallic element 7 is depicted in which the bimetallic element 7 is shorter than in the first embodiment and is attached (e.g., soldered) to a hollow-cylindrically shaped retaining element 9, preferably made of steel. The retaining element 9 is mounted in the retaining section 8 of the seal base body 3. It thus results that with temperature increase practically only the first seal lip 4 lifts away from the shaft 6, while the second seal lip 5 does not change its position.

The first and second seal lips 4, 5, and specifically their end edges that make contact with the shaft 6, can themselves be shaped very precisely by cutting-off using a cut-off knife, and the shape tolerance can be kept in a range of +/−0.15 mm.

Using the disclosed design, it is possible to ensure that, with a temperature increase, the shape change of the temperature-sensitive adjusting element 7 affects the radial position of the first seal lip 4 more than it affects the radial position of the second seal lip 5. It may even be possible to lift the first seal lip 4 completely off the countersurface.

At the same time, the second seal lip 5 is only slightly withdrawn or not withdrawn at all from the shaft 6, so that the tightness of the seal assembly is ensured in any case. However, in an advantageous manner the friction in operation noticeably decreases.

The disclosed seal assembly can be installed as a separate unit between housing and shaft.

However, it is also possible for it to be integrated in a rolling-element bearing; then the seal lips 4 and 5 run against one of the bearing rings.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved temperature responsive seals.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Seal assembly

2 First component (housing)

3 Seal base body (made of metal plate)

4 First seal lip

5 Second seal lip

6 Second component (shaft)

7 Temperature-sensitive adjusting element (bimetallic element)

8 Retaining section

9 Retaining element (made of steel)

10 Elastomer material

11 Slots

A First space

B Second space

P Arrow

a Axial direction

L Bend line in the case of increased temperature

We claim:

1. A seal assembly for sealing a first space with respect to a second space, the seal assembly including a seal base body disposed on a first component and having at least first and second seal lips configured to run on a running surface of a second component, the second component having an axis of rotation extending in an axial direction, the first seal lip and the second seal lip being spaced from each other in the axial direction, the seal assembly further including at least one temperature-sensitive adjusting element disposed in the seal base body and configured to change shape in response to a temperature increase, wherein the temperature-sensitive adjusting element comprises a sleeve extending in the axial direction and being concentric to the axis of rotation, wherein one end of the temperature-sensitive adjusting element extends into a portion of the seal base body, wherein an other axial end of the temperature-sensitive adjusting element is spaced from the seal base body, wherein the seal base body includes a retaining section for retaining the one end of the temperature-sensitive adjusting element, the retaining section being configured as a bent section, wherein the retaining section holds the one axial end of the temperature-sensitive adjusting element or a retaining element to which the temperature-sensitive adjusting element is attached.

2. The seal assembly according to claim 1, wherein the temperature-sensitive adjusting element is configured such that, in response to a temperature increase, the first seal lip moves radially away from the second component and the second seal lip does not move radially away from the second component.

3. The seal assembly according to claim 1, wherein the temperature-sensitive adjusting element is a bimetallic element or comprises a bimetallic element.

4. The seal assembly according to claim 1, wherein the sleeve includes circumferentially spaced slots at least over a part of its axial extension.

5. The seal assembly according to claim 1, wherein the seal base body is comprised of a bent metal-plate element.

6. The seal assembly according to claim 1, wherein the seal base body is at least partially encased in elastomer material, wherein the seal lips are formed from the elastomer material.

7. The seal assembly according to claim 1, wherein the temperature-sensitive adjusting element is a bimetallic element or comprises a bimetallic element, wherein the sleeve includes circumferentially spaced slots at least over a part of its axial extension, wherein the seal base body is comprised of a bent metal-plate element, wherein the seal base body is at least partially encased in elastomer material, and wherein the seal lips are formed from the elastomer material.

8. A seal assembly for sealing a space between a first component and a second component, the second component having an axis of rotation extending in an axial direction, the seal assembly comprising:
a seal base body disposed on the first component and having at least first and second seal lips configured to run on a running surface of the second component with the seal lips contacting the second component at first and second axially spaced locations, the seal base body including an annular channel having an opening facing in the axial direction, and
at least one cylinder comprising a bimetallic shape-change element, the cylinder having a first cylinder end in the annular channel of the seal base body and a second cylinder end outside the annular channel, at least a portion of the cylinder being located axially between the first seal lip and the second seal lip and radially inward or outward of the second seal lip.

9. The seal assembly according to claim 8, wherein the second seal lip is located axially between the first seal lip and the annular channel and wherein the bimetallic shape-change element extends from the annular channel axially past the second seal lip toward the first seal lip.

10. The seal assembly according to claim 8, wherein the bimetallic shape-change element is connected to a metallic cylinder and wherein the first cylinder end comprises a portion of the metallic cylinder.

11. The seal assembly according to claim 8, wherein the bimetallic element includes a plurality of slots extending axially inward from the cylinder second end.

12. The seal assembly according to claim 8, wherein the cylinder is located radially outward of the second seal lip.

13. The seal assembly according to claim 8 wherein an outer diameter of the first cylinder end is substantially the same as an outer diameter of the second cylinder end.

14. The seal assembly according to claim 8,
wherein the second seal lip is located axially between the first seal lip and the annular channel and wherein the bimetallic shape-change element extends from the annular channel axially past the second seal lip toward the first seal lip,
wherein the bimetallic element includes a plurality of slots extending axially inward from the cylinder second end,
wherein the cylinder is located radially outward of the second seal lip, and
wherein an outer diameter of the first cylinder end is substantially the same as an outer diameter of the second cylinder end.
